(19) United States
(12) Patent Application Publication
(10) Pub. No.: US 2012/0136463 A1
(43) Pub. Date: May 31, 2012

(54) Method for Quantifying the Productivity of Basketball Players, Teams and Coaches

(76) Inventor: Sotero Muniz, Polson, MT (US)

(21) Appl. No.: 12/845,592

(22) Filed: Jul. 28, 2010

Related U.S. Application Data
(60) Provisional application No. 61/271,978, filed on Jul. 29, 2009.

(51) Int. Cl. G06F 19/00

(52) U.S. Cl. 700/91

(57) ABSTRACT

A method for determining objective basketball productivity ratings for players, teams and coaches that includes using nine of the twenty-four statistics tracked in basketball. Each of the selected statistics is assigned a parity constant value based on the overall impact the statistic has on the outcome of the basketball game. Through a series of calculations, the offensive basketball productivity rating and the defensive productivity rating of an individual, team and/or coach are combined to determine the overall basketball productivity.

### CROSS REFERENCE TO RELATED APPLICATION

This application claims the benefit of U.S. Provisional Application Ser. No. 61/271,978 filed Jul. 29, 2009 by Sotero Muniz.

### FIELD OF THE INVENTION

The present invention relates generally to the field of productivity analysis, and more particularly to a system and method for establishing basketball productivity ratings for basketball players, teams and coaches.

### BACKGROUND OF THE INVENTION

Typically, those assessing a basketball player's skill level have used criteria that focus on a basketball player's offensive statistics. Their analysis encompasses only a part of an overall skill set and is further limited by excluding negative scoring and non-scoring plays. Today, there is no consensus on who are among the best basketball players because there is no single rating system accepted by basketball statisticians, coaches, owners, commentators or scouts. Differences exist because most analyses are based primarily on subjective opinion. Moreover, those analyses also rely heavily on offensive output. There is a need for a system and method that provides an accurate and objective means for quantifying basketball player's overall productivity.

### SUMMARY OF THE INVENTION

Contributions to the game of basketball consist of scoring plays, either a 3, 2 or 1 point shot and five non-scoring plays, blocked shots, steals, assists, rebounds and turnovers. Scored points have fixed, objective values. The number of some non-scoring plays are reported but their contributions are subjective, their values undetermined and without consensus. Present day objective comparisons, rankings or ratings of players and teams are limited by the exclusion of quantified contributions of non-scoring plays. The present invention corrects this deficiency.

Each basketball play has either a positive or negative impact on the outcome of a game. The present invention defines each play as either offensive or defensive and separates and quantifies each type of play. Offensive plays are total points scored, assists and turnovers and provide offensive productivity ratings (“OPRs”). Defensive plays are blocked shots, steals and rebounds and provide a defensive productivity rating (“DPR”). I have created parity constants for each of the non-scoring plays. Parity constants have positive and negative values and convert each play into a normalized value that can be quantified. This allows for a statistically valid comparison of scoring and non-scoring plays and provide an overall basketball productivity rating (“BPR”) for each player.

The net contributions players make while on the court define their productivity and relate directly to their skills in executing plays. These contributions are the bases of each player's BPR.

In one aspect of the invention, it provides ratings, rankings and objective comparisons of all basketball players in games that use the same statistics.

In another aspect of the invention, it provides fully comparable productivity rankings (between players, coaches and teams within any given league) with objective certainty of the relative skill ranking of all players on any particular team.

In another aspect of the invention, it provides a means for selecting the most productive players for all-star teams, Olympic teams, all-American teams, and all-conference teams.

In another aspect of the invention, it provides a means for identifying the most improved players on a team or in a league.

In another aspect of the invention, it provides a universal recruiting tool at high school, college, university and professional levels.

In another aspect of the invention, it provides a means to document a basketball player's weaknesses and improvements,

In another aspect of the invention, it provides a means for identifying what skills a basketball player needs to practice in order to improve his or her overall productivity.

In another aspect of the invention, it provides a means for identifying appropriate practice and drills for a coach to emphasize if the coach desires to improve the productivity of an individual or team.

In another aspect of the inventions, it provides a fair basis for correlating performance with salary and bonus decisions.

In another aspect of the invention, subjectivity with the management of a basketball game will yield to a more objective analysis of a player's and/or team's performance.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 is a flow chart of a method for establishing basketball productivity ratings for assessing a basketball player's productivity.

FIG. 2 is an example of the application of the invention disclosed herein to determine best individual season and individual career overall productivity.

### DETAILED DESCRIPTION OF THE INVENTION

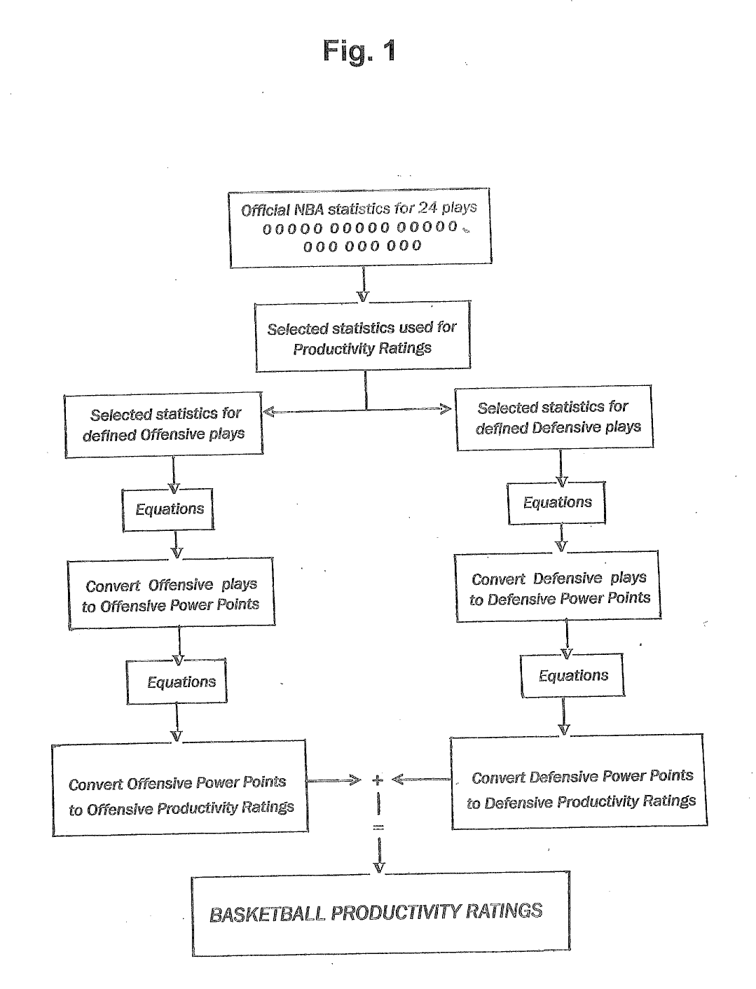

FIG. 1 illustrates a method for establishing a basketball player's productivity rating. Statistics are kept for virtually all basketball games occurring at the high school level and above. The method begins at step 1, where statistics (three point field goals made, two point field goals made, free throws made, free throws missed, assists, turnovers, blocked shots, steals and rebounds) are selected to generate productivity ratings. In step 2, the plays are separated into offensive plays (three point field goals made, two point field goals made, free throws made, free throws missed, assists and turnovers) and defensive plays (blocked shots, steals and rebounds). In step 3, parity constants are used to calculate the power points of each offensive or defensive play. Parity constants for positive scoring plays are determined by the value given the particular scoring play. A parity constant of 3 for three point field goals made, 2 for two point field goals made and 1 for free throws made. Free throws missed are assigned a parity constant of −1 because it results in a missed opportunity to provide a positive contribution to the game. The maximum parity constant value for non-scoring plays is constrained to 1.9 in order to establish the primacy of a field goal's two point value over all non-scoring plays. The number of positive non-scoring plays made is a measure of the skill required to execute each particular play. The skill level is determined by the frequency of each play's occurrence for each player within a game or season. For instance, statistically there are fewer blocked shots made than steals, fewer steals than assists and fewer rebounds than assists. There are fewer blocked shots than any other play because they must be more difficult to execute so logically, blocked shots are assigned the highest non-scoring parity constant value of 1.9. Steals, which occur next most seldom, have a value of 1.7, assists a value of 1.5 and rebounds a value of 1.3. Turnovers, which have a parity constant value of −1.6, and missed free throws, parity constant value of −1, are treated as negative plays because they take away an opportunity to score. Turnovers are the most destructive plays. They can cause six point swings. Steals create turnovers, which have a parity constant of −1.6 so “earn” a parity constant of 1.7. The sum of this spread is 3.3, about the statistical midpoint of the maximum six point swing.

For purposes of computing the overall basketball productivity rating, rebounds are not separated into offensive rebounds or defensive rebounds. There are more rebounds than any other play, and about 50% of the time, the ball's bounce selects the rebounder. This randomness lessens the skill required to get a rebound and explains the relatively low parity constant value of 1.3. For productivity purposes, a rebound is defined as a defensive play because it defends against a possession by the other team. Rebounds require the same skills at either end of the court. Using parity constant protocols establishes statistical comparability between all plays and their productivity ratings. Existing references to offensive and defensive rebounds are an accepted, descriptive and well understood part of the game's commentary and should be continued. All rebounds are still accounted for and their contributions are reported separately in productivity terms.

The results of each non-scoring play also influenced its assigned parity constant value. An assist always results in a field goal. Turnovers always result in a possession change. A blocked shot always disrupts an offensive scoring play. The party constant values were tested in ranges relative to other parity constant values. The logic of their final values was reinforced by observing their effects in hundreds of games.

Multiplying the number of scoring or non-scoring plays by its parity constant results in power points for each play. For instance, the power points for three point field goals are number of three point field goals made, multiplied by 3. The power points for two point field goals made are number of field goals made multiplied by 2. The power points for free throws made are number of free throws made multiplied by 1. The power points for free throws missed are number of free throws missed multiplied by −1. The power points for blocked shots are number of blocked shots multiplied by 1.9. The power points for steals are number of steals multiplied by 1.7. The power point for assists is number of assists multiplied by 1.5. The power point for total rebounds is number of total rebounds multiplied by 1.3. The power point for turnovers is number of turnovers made multiplied by −1.6. The use of parity constants establishes parity between historically disparate plays. Converting plays to power points enables statistical comparability of all power points, scoring or non-scoring. Overall offensive productivity can be determined by adding scoring power points (three point field goal power points, two point field goal power points and free throws made power points) to assist power points and then subtracting negative turnover power points and negative missed free throw power points. Defining negative offensive plays and power points recognizes that negative productivity has to be included in establishing offensive productivity ratings. Three point field goals power points, two point field goal power points, free throws made power points, free throws missed power points, assists power points and turnovers power points are added to create offensive power points. Blocked shots power points, steals power points and rebound power points are added together to create defensive power points.

In step 4, an equation is applied to convert power points into offensive (“OPRs”) or defensive productivity ratings (“DPRs”). The equation for OPR is [(offensive power points)+(player minutes)]×1,000. The equation for DPR is [(defensive power points)+(player minutes)]×1,000. The “1000” productivity constant creates separation between all ratings and establishes ratings to the nearest tenth of a point (to avoid ties). They are surprisingly stable. Each are divided by actual minutes played so statistically, they are absolutely fair. In step 5, OPR and DPR are added together to arrive at an overall basketball productivity rating (“BPR”) for a player.

Initially BPRs were pursued to quantify the productivity of players. It became evident, however, that a BPR could be determined for a team and even a coach. By definition, the sum of the OPR and DPR of every player with player minutes in a game is the BPR of the team. Coaches control every player minute allocation and substitutions so the team's OPR and DPR are determined by the coach. By definition, the team's BPRs for every game are the combined BPRs of each individual player from every game. Analyses led to other conclusions. BPRs can be computed for a game, or even a part thereof, a series, a season and for careers of players, and coaches. In sum BPRs are based on nine official statistics of the game, using every positive and negative, scoring and non-scoring play made, for every player's minutes in a game, season or career. The quantified BPR can now be used to objectively compare performance in every offensive and defensive play by every player in every game.

Once PRs (the sum of OPRs+DPRs) have been established for 2 players, or a team or any number players, they can be ranked in order from the most productive player to the least productive. An absolute method for finding the best NBA, WNBA, etc. player of all time and those that follow is now available for the first time in the game's history.

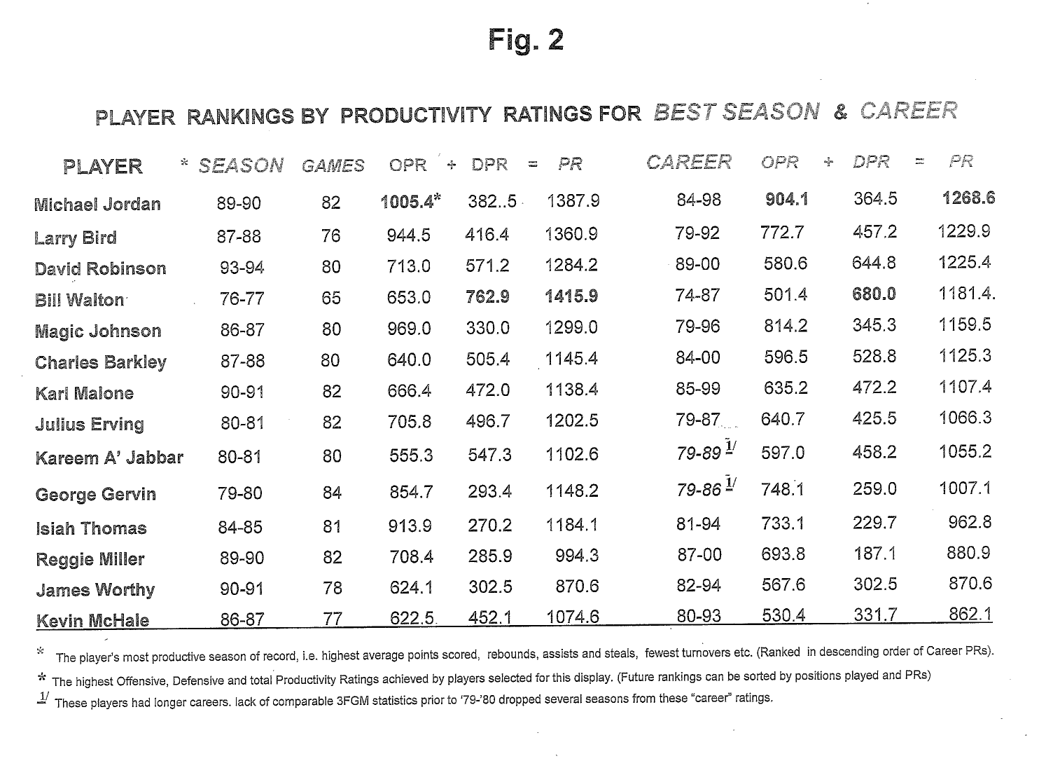

BPRs are valid in any level of the game. They are unaffected by floor geometry or length of playing periods and they are gender neutral. They isolate skill deficits, measure and track increases or decreases of player's skills based on the players own performance history. Recognition awards like the most improved player, rookie of the year, the best 6^{th} man, MVPs, selecting all star game players, Olympics participants, the offensive and defensive players of the year etc. are part of the game. Using BPRs as award criteria will improve the objectivity of these selections. Coaches and players can isolate areas in which they need to improve that would increase productivity and track those improvements using valid and relevant statistical changes. FIG. 2 provides an example of how the invention disclosed herein can be used to determine the best season and career for individual players.

What is claimed is:

1. A method of determining the productivity of a basketball player comprising:
recording offensive basketball statistics for an individual basketball player;
recording defensive basketball statistics for an individual basketball player;
selecting particular offensive statistics to be used in determining the individual player's productivity;
selecting particular defensive statistics to be used in determining the individual player's productivity;
assigning a parity constant value to each of said selected offensive and defensive statistics;
creating a power point value for each of said selected statistics by multiplying each of said selected statistics by said assigned parity constant;
obtaining an offensive productivity rating for an individual basketball player by adding said power point values for the selected offensive statistics, dividing the sum of the power point values for the selected offensive statistics by the number of player minutes and multiplying the result by a productivity constant;
obtaining a defensive productivity rating for an individual basketball player by adding said power point values for the selected defensive statistics, dividing the sum of the power point values for the selected defensive statistics by the number of player minutes and multiplying the result by a productivity constant; and
obtaining a basketball productivity rating for an individual basketball player by adding said offensive productivity rating and said defensive productivity rating.

2. The method of claim 1 wherein said selected offensive statistics are two point field goals made, three point field goals made, free throws made, free throws missed, assists and turnovers and said selected defensive statistics are blocked shots, total rebounds and steals.

3. The method of claim 1 wherein said parity constant values for each non-scoring basketball play is determined by the average frequency within which said non-scoring basketball play occurs.

4. The method of claim 1 wherein said productivity constant is 1000.

5. The method of claim 2 wherein three point field goals made are assigned a parity constant value of 3, two point field goals made are assigned a parity constant value of 2, free throws made are assigned a parity constant value of 1, missed free throws are assigned a parity constant value of −1, assists are assigned a parity constant value of 1.7, turnovers are assigned a parity constant value of −1.6, blocked shots are assigned a parity constant value of 1.9, total rebounds are assigned a parity constant value of 1.3 and steals are assigned a parity constant value of 1.7.

6. A method of determining the productivity of a basketball team comprising:
recording offensive basketball statistics for a team;
recording defensive basketball statistics for a team;
selecting particular offensive statistics to be used in determining the team's offensive productivity;
selecting particular defensive statistics to be used in determining the team's defensive productivity;
assigning a parity constant value to each of said selected offensive and defensive statistics;
creating a power point value for each of said selected statistics by multiplying each of said selected statistics by said assigned parity;
obtaining an offensive productivity rating for a team by adding said power point values for the selected offensive statistics, dividing the sum of the power point values for the selected offensive statistics by the total number of player minutes and multiplying the result by a productivity constant;
obtaining a defensive productivity rating for a team by adding said power point values for the selected defensive statistics, dividing the sum of the power point values for the selected defensive statistics by the total number of player minutes and multiplying the result by a productivity constant; and
obtaining a basketball productivity rating for a team by adding said offensive productivity rating and said defensive productivity rating.

7. The method of claim 6 wherein said selected offensive statistics are two point field goals made, three point field goals made, free throws made, free throws missed, assists and turnovers and said selected defensive statistics are blocked shots, total rebounds and steals.

8. The method of claim 6 wherein said parity constant values for each non-scoring basketball play is determined by the average frequency within which said non-scoring basketball play occurs.

9. The method of claim 6 wherein said productivity constant is 1000.

10. The method of claim 7 wherein three point field goals made are assigned a parity constant value of 3, two point field goals made are assigned a parity constant value of 2, free throws made are assigned a parity constant value of 1, missed free throws are assigned a parity constant value of −1, assists are assigned a parity constant value of 1.7, turnovers are assigned a parity constant value of −1.6, blocked shots are assigned a parity constant value of 1.9, total rebounds are assigned a parity constant value of 1.3 and steals are assigned a parity constant value of 1.7
